(19) United States
(12) Patent Application Publication
(10) Pub. No.: US 2005/0256996 A1
(43) Pub. Date: Nov. 17, 2005

(54) Register read circuit using the remainders of modulo of a register number by the number of register sub-banks

(76) Inventor: Mitsuhiro Watanabe, Tokyo (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/169,735

(22) Filed: Jun. 30, 2005

Related U.S. Application Data
(62) Division of application No. 10/245,393, filed on Sep. 18, 2002.

(30) Foreign Application Priority Data
Sep. 20, 2001 (JP) 2001-286102

(51) Int. Cl. G06F 12/00

(52) U.S. Cl. 711/5

(57) ABSTRACT

A register read circuit reads out register values of X (natural number) registers corresponding to selection register numbers. The registers are each assigned to a unique register number. Register numbers that correspond to the X registers to be selected among the registers are given to the register read circuit as the selection register numbers' The register read circuit includes register value selection circuits each of which selects the register value of one of the X registers corresponding to the register numbers associated with remainders of modulo of the register numbers by Y, which is a natural number larger than or equal to X. Each of the selection circuits selects and outputs one of register values from the registers in response to a selection control input based on the given register number, the register value selection circuits being correspondent to the remainders.

### BACKGROUND OF THE INVENTION

1. Field of the Invention

The present invention relates to a register read circuit and a microprocessor, which is applicable to, for example, reading out data from a plurality of registers of a register bank.

2. Description of the Background Art

A microprocessor, especially, a RISC (Reduced Instruction Set Computer) based one, uses high-speed internal general-purpose registers exclusively for use in executing operations including addition, subtraction, and shift. This method simplifies the hardware required for executing instructions but increases the frequency of an operational clock for higher performance.

Recently, even low cost, low power-consumption small size, 8-bit microprocessors, where operations such as addition and subtraction are executed with 8 bits at a time, use the RISC architecture. On those microprocessors, it becomes common to develop program sequences using high-level languages such as the C language.

On a 32-bit or a 64-bit processor, the user may usually specify a kind of instructions where an operation-result storage register is specified in addition to registers to be used for addition or subtraction per se. More specifically, the user may specify an instruction such as Example 1 where three registers (or more depending upon the operation) are specified in its operand. This is because the instruction word is also 32 bits or 64 bits long on such a processor and this word length is long enough for specifying the operands.
Example 1
ADD Ri, Rj, Rk
   (Add up the contents of register Rj and the contents of register Rk, and store the result in register Ri)

However, on an 8-bit or a 16-bit processor, the instruction word length is in most cases, 16 bits or so. In such an instruction word, only the operator and the registers to be used are specified, and the result is overwritten into one of the operands as in Example 2.
Example 2
ADD Rn, Rm
   (Add up the contents of register Rn and the contents of register Rm, and the result is written into register Rn. The original value of register Rn will be lost)

For example, when the instruction word length is 16 bits and there are 16 registers, a 4-bit field is required for specifying one of the registers. An instruction with two operands requires 8 bits with the remaining 8 bits available for specifying an operator. However, an instruction with three operands requires 12 bits with only four bits available for specifying an operator. In the latter case, all instructions to be implemented on the processor may not fit in 4 bits.

In the above case, an implicit operand shown in Examples 3 and 4 is usually provided to solve the problem.
Example 3
STORE Rn, [ERm]
   (Store the contents of register Rn in a memory location whose address has more and less significant positions specified by registers Rm+1 and Rm, respectively. Only an even number (or an odd number) may be specified for m).
Example 4
SRL Rn, Rm
   (Shift right data whose more and less significant positions include data stored in registers Rn+1 and Rn, respectively, by the number of positions specified by register Rm, and store the less significant bits of the shift result into register Rn)

With the implicit-operand system, the way of specifying the registers is different from instruction to instruction to allow one register specified by an operand to automatically select a plurality of registers for use by the instruction. For example, because eight bits are too few to specify a storage location in the address space for memory-to-register data transfer, usually two 8-bit registers are combined to generate a 16-bit address value. In this case, the instruction decoder is designed to use the more significant register implicitly by specifying only the less significant register for the instruction. This method saves one register-specifying field (four bits when there are 16 registers) and makes this field available for use by other instruction or processing options.

Implicit register specification depends on the architecture. However, because of the limitation on the word length and the number of operands of the instructions described above, the instruction structure based upon the concatenation of any two registers does not give an advantage. Such an instruction structure could therefore ensure its increased space efficiency that a storage location is addressed by only two consecutive registers, and only the less or more significant register is specified for an instruction in a program sequence to enable one register field to resultantly specify two registers.

For an implicit operand instruction system described above to be implemented on a RISC based microprocessor in the pipeline mode, three registers must be selected and read from the register bank simultaneously. For example, the instruction in Example 3 described above reads three registers, Rn, Rm+1, and Rm, and the instruction in Example 4 also described above reads three registers, Rn+1, Rn, and Rm.

When the register bank is composed of 16 general-purpose registers, each having m bit positions, there would be a method that uses fifteen 2-to-1 multiplexers of m-bit length for each operand, in other words, for each 16-to-1 multiplexer, adapted for selecting one from 16. In this case, a three-operand instruction requires forty-five 2-to-1 multiplexers of m-bit length.

A 2-to-1 multiplexer of m-bit length is composed of m 2-to-1 multiplexers of one-bit length. Therefore, when this method is used, the register read circuit in its entirety requires a total of 360 (=45*8) 2-to-1 multiplexers of one-bit length when the register has 8 bit position, i.e. m=8. Therefore, this circuit takes up much space on the integrated circuit chip.

In addition, this method requires as many as 384 wiring connections (=16 registers*8 bits*3 operands) between the register bank and the multiplexers, also taking up on the chip additional space, which cannot be made little of. In a configuration with more registers or more bits in each register, the register read circuit requires more space on the chip.

### SUMMARY OF THE INVENTION

It is there for an object of the invention to provide a register read circuit with a structure suitable for implementation, and easy for installation, on an integrated circuit chip.

It is another object of the invention to provide a microprocessor containing a register read circuit with a structure easy for installation on a chip.

In accordance with the invention, a register read circuit for reading out register values selectively from a first plurality of registers assigned to register numbers different from each other comprises: a selection register number receiving circuit for receiving selection register numbers corresponding to a second plurality of registers to be selected among said first plurality of registers; and a third plurality of register value selectors each provided correspondingly to predetermined one of remainders of modulo of the register numbers by the third plurality for receiving the register values contained in ones of said first plurality of registers which correspond to the register numbers of which the remainder of the modulo by the third plurality has a predetermined value, which is different between said third plurality of register value selectors, the third plurality being not smaller than the second plurality, each of said third plurality of register value selectors selecting and outputting one of the received register values which is associated with a selection control signal based on the received selection register number of which the remainder of the modulo by the third plurality has one of the predetermined values.

Further in accordance with the invention, a microprocessor is provided which comprises: a first plurality of registers assigned to register numbers different from each other; an instruction decode circuit for decoding an instruction and selecting and outputting one of the register numbers, which corresponds to one of said first plurality of registers from which a register value is to be read out, as a selection register number; and the register read circuit, described above, for reading out the register values selectively from said first plurality of registers.

More specifically, a register read circuit is adapted to read out register values of a natural number, X, registers corresponding to selection register numbers. The registers are each assigned to a register number different from each other. Register numbers corresponding to the X registers to be selected among the registers are given to the register read circuit as the selection register numbers. The register read circuit includes register value selection circuits each of which selects the register value of one of the X registers corresponding to the register numbers associated with remainders of modulo of the register numbers by Y, which is a natural number larger than or equal to X. Each of the selection circuits selects and outputs one of register values from the registers in response to a selection control input based on the given register number, the register value selection circuits being correspondent to the remainders.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the configuration of a register read circuit in accordance with a preferred embodiment;

FIG. 2 is a schematic block diagram showing the configuration of a conventional register read circuit for comparison;

FIG. 3 is a schematic block diagram showing the detailed configuration of a 16-to-1 multiplexer included in the configuration shown in FIG. 2;

FIG. 4 is a schematic block diagram showing primary components of a microprocessor comprising the register read circuit shown in the embodiment shown in FIG. 1;

FIGS. 5 and 6 show an example of the configuration of an even and an odd register number selection circuit in the embodiment, respectively;

FIGS. 7 and 8 are diagrams useful for understanding the operation of the register read circuit in the embodiment; and

FIGS. 9A and 9B are a schematic block diagram showing the configuration of a register read circuit in accordance with an alternative embodiment of the invention.

### DESCRIPTION OF THE PREFERRED EMBODIMENTS

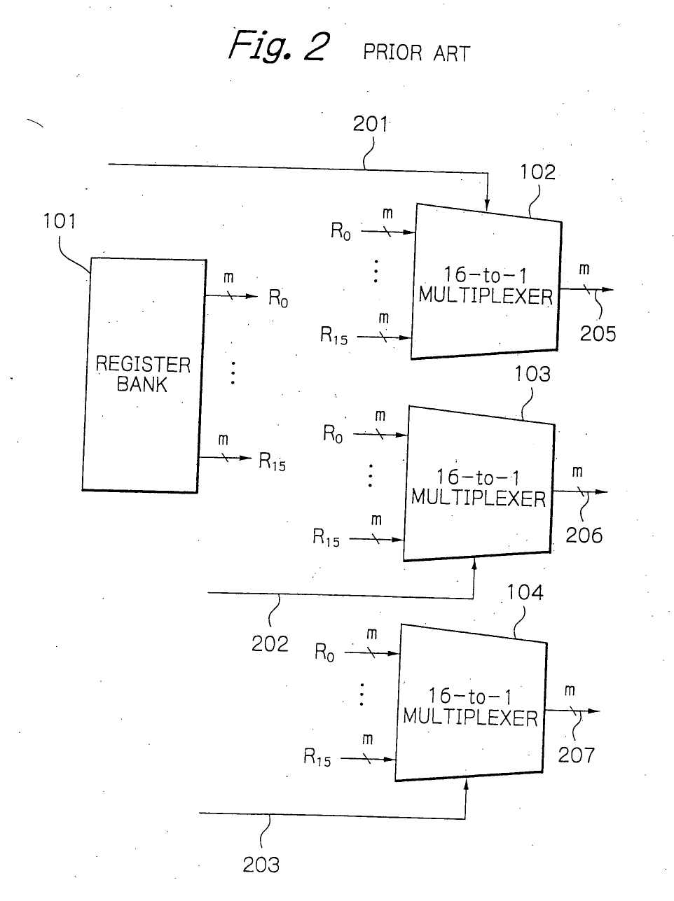

Before describing embodiments of the present invention, a method in which one 16-to-1 multiplexer is used for one operand will be described for comparison with the present invention. FIG. 2 is a block diagram showing a conventional register read circuit designed in accordance with this method. This circuit can read three registers at a time from a register bank composed of 16 registers.

In FIG. 2, the contents of 16 registers R0-R15, each having m bit positions, of a register bank 101 can be sent to each of three 16-to-1 (16 inputs and one output) multiplexers 102-104 of m-bit length. Register numbers specified by operands 1, 2 and 3 are sent to the multiplexers 102, 103 and 104 at the selection inputs 201, 202 and 203 thereof, respectively. Each of the multiplexers 102, 103′, and 104 selects the register corresponding to the register number and outputs the contents, or register value, of the selected register on its operand output 205, 206 or 207.

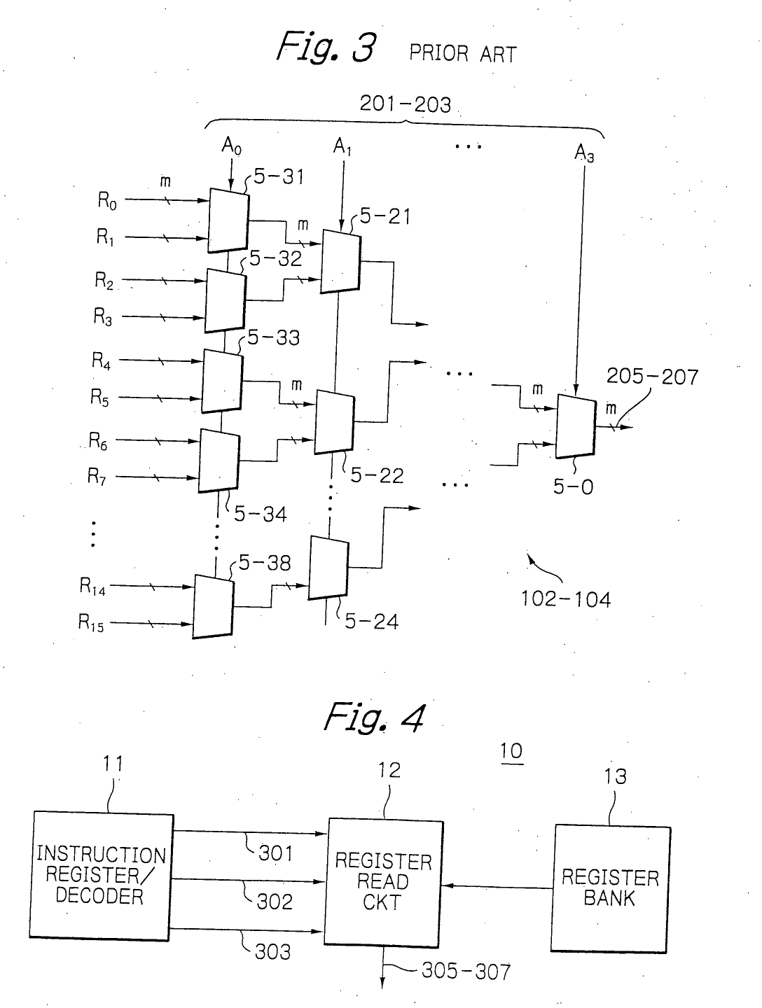

On an LSI (Large Scale Integrated circuit), such as an ASIC (Application-Specific Integrated Circuit) or a cell-based integrated circuit composed of a combination of basic gates, the multiplexers 102, 103 and 104 are configured as a tree structure, in many cases, by connecting 2-to-1 (two inputs to one output) multiplexers as shown in FIG. 3.

In FIG. 3, the eight 2-to-1 multiplexers 5-31-5-38 first select m-bit outputs from eight of the 16 registers R0-R15 in response to the least-significant bit A0 of the selection input 201, 202 or 203. Then, the four 2-to-1 multiplexers 5-21-5-24, with 5-23 not shown in the figure, select the data from four of the eight registers according to the next less significant bit A1. In turn, the two 2-to-1 multiplexers 5-11 and 5-12, both not shown, select data from two registers according to the next less significant bit A2. Finally, one 2-to-1 multiplexer 5-0 selects one register according to the most significant bit A3.

As understood from FIG. 3, when there are 16 general-purpose registers, one operand, i.e. one 16-to-1 multiplexer, requires fifteen 2-to-1 multiplexers of m-bit length or m bit positions. When there are three operands as shown in FIG. 2, forty-five 2-to-1 multiplexers of m-bit length or m bit positions are required.

Therefore, a register having eight bit positions requires the register read circuit in accordance with this method to include a total of 360 (=45*8) 2-to-1 multiplexers of one-bit length, taking up much space on the IC chip.

With reference to the accompanying drawings, a preferred embodiment of a register read circuit included in a microprocessor according to the present invention will be described. With reference to FIG. 4, a microprocessor 10 in the embodiment includes an instruction register/decoder 11, a register read circuit 12, and a register bank 13 interconnected as illustrated.

The instruction register/decoder 11 is adapted to retain and decode an instruction received from other circuit components, not shown, of the microprocessor 10, send out information on the basis of the decoded instruction to an arithmetic logic unit (ALU), not shown, and send data on up to three operands (register numbers) to the register read circuit 12 to operand selection inputs 301, 302 and 303.

In the embodiment, an instruction to be decoded by the instruction register/decoder 11 may be of an implicit operand such as the one shown in Examples 3 and 4 When such an instruction is decoded, the instruction register/decoder 11 outputs the consecutive register numbers to the operand selection inputs 302 and 303. Note that the instruction register/decoder 11 may be adapted to decode an instruction for which up to three explicit operands are specified.

Although, in the embodiment described below, the register read circuit 12 is adapted to receive the operand selection inputs 302 and 303 in the form of consecutive register numbers, the read circuit 12 may be adapted to receive the operand selection inputs 302 and 303 in the form of any non-consecutive register numbers as long as one is an even number and the other is an odd number.

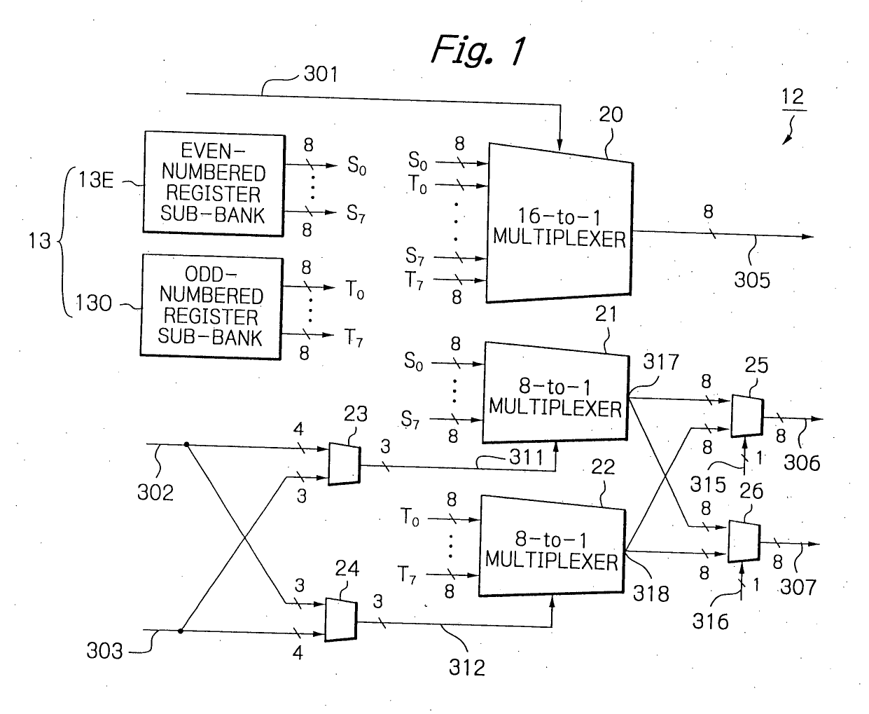

The register read circuit 12, with the detailed configuration shown in FIG. 1, is adapted to read out the contents, or register value, of a register, whose number is specified by the operand selection inputs 301, 302 and 303 (register number) output by the instruction register/decoder 11, from the register bank 13 and output the value from an operand output 305, 306 or 307 thereof. The operand output 305, 306 or 307 that has been readout is interconnected to be sent, for example, to the arithmetic and logical unit (ALU) via a system bus, not shown, or once stored in a temporary register and then sent to the arithmetic and logical unit (ALU).

In the embodiment, the register bank 13 comprises, as shown in FIG. 1, an even-numbered register sub-bank 13E composed of even-numbered registers and an odd-numbered register sub-bank 13O composed of odd-numbered registers. In the figures, like components are designated with the same reference numerals.

For simplicity to implement an instruction system easily, the embodiment shown in FIG. 1 specifically includes 16 registers, where N=16, which are represented by the four bits of a register number, where 2⁴=16, 2ⁿ=N in general. That is, the register number ranges from 0 to 15 in decimal notation. When the register number reaches the maximum (N−1=15; odd number) the next consecutive number is 0 (even number) that is considered larger than the maximum by 1.

Referring to FIG. 1, the register read circuit 12 comprises an 16-to-1 multiplexer of 8-bit length 20, two 8-to-1 multiplexers of 8-bit length 21 and 22, an even register number selection circuit 23, an odd register number selection circuit 24, and two 2-to-1 multiplexers of 8-bit length 25 and 26.

In addition, as described above, the register bank 13, from which the register read circuit 12 in the embodiment reads registers, comprises the even-numbered register sub-bank 13E and the odd-numbered register sub-bank 13O. The even-numbered register sub-bank 13E comprises even-numbered registers, of which the least significant bit is 0. The contents of the even-numbered registers, S0, . . . , S7 (each 8 bits), are sent to the 16-to-1 multiplexer 20 and the 8-to-1 multiplexer 21. The register values S0, . . . , S7 are the contents of the registers numbered as 0, 2, . . . , 14 in decimal expression, respectively.

Likewise the odd-numbered register sub-bank 13O contains odd-numbered registers, of which the least significant bit is 1. The contents of the odd-numbered registers, T0, . . . , T7 (each 8 bits), are sent to the 16-to-1 multiplexer 20 and the 8-to-1 multiplexer 22. The register values T0, . . . , T7 are the contents of the registers numbered as 1, 3, . . . , 15 in decimal expression, respectively.

The even-numbered registers constituting the even-numbered register sub-bank 13E need not form a geometrical group, nor the odd-numbered registers constituting the odd-numbered register sub-bank 13O. As long as the register sub-banks are configured functionally, the even-numbered and odd-numbered registers may be mixed in physical.

The 16-to-1 multiplexer 20 is adapted to select, among all even-numbered and odd-numbered register values S0-S7 and T0-T7, the register value corresponding to the register number specified by the operand selection input 301 received from the instruction register/decoder 11, and output the selected register value from the operand output 305. The detailed configuration of the 16-to-1 multiplexer 20 may be the same as that of the multiplexer shown in FIG. 3 described above.

The 8-to-1 multiplexer 21 is adapted to select, among the even-numbered register values S0-S7, the register value corresponding to the register number 311 specified by the even register number selection circuit 23, and output the selected register value to two 2-to-1 multiplexers 25 and 26. The selection circuit 23 is adapted for producing on its output 311 three bits more significant than the least significant bit, which is always 0.

Similarly, the 8-to-1 multiplexer 22 is adapted to select, among the odd-numbered register values T0-T7, the register value corresponding to the register number 312 specified by the odd register number selection circuit 24, and output the selected register value to two 2-to-1 multiplexers 25 and 26. The selection circuit 24 is adapted for producing on its output 312 three bits more significant than the least significant bit, which is always 1. The detailed configuration of the 8-to-1 multiplexers 21 and 22 may be of the same tree structure as that of the multiplexer shown in FIG. 3 except that the tree structure hierarchy depth is 3 although 4 in FIG. 3.

The even register number selection circuit 23 is adapted to select an operand designating an even-numbered register from the operand selection inputs 302 and 303 sent from the instruction register/decoder 11. For example, this circuit 23 outputs three bits, from the second to fourth least significant bits, of the operand selection inputs 302 and 303 whose least significant bit is 0, where the fourth least significant bit is most significant. When both operand selection inputs 302 and 303 indicate an even-numbered register, the circuit 23 outputs arbitrarily. This circuit 23 may be adapted to output the entire four bits indicating the selected register number.

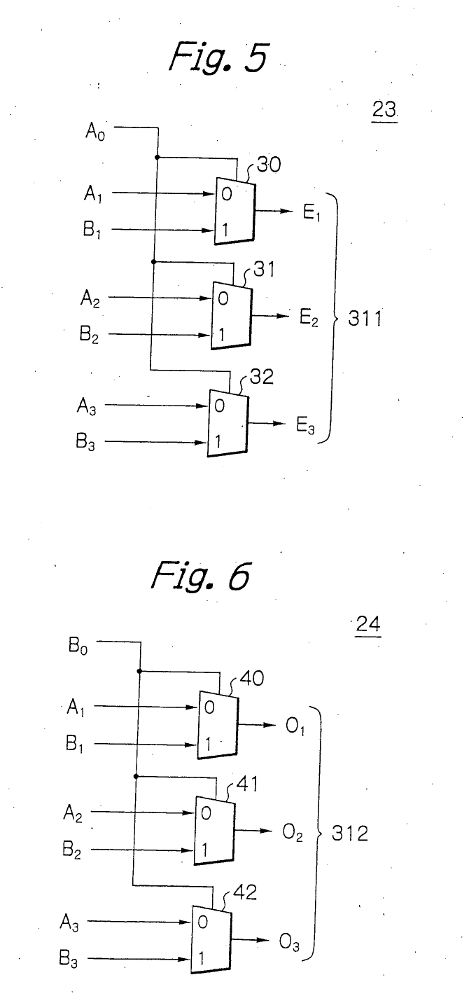

Referring now to FIG. 5, the even register number selection circuit 23 comprises three 2-to-1 multiplexers of 1-bit length 30-32. The least significant bit A0 of the four bits A0-A3 of the operand selection input 302 is used as the selection control signal for the 2-to-1 multiplexers 30, 31 and 32. The remaining bits, A1, A2 and A3, are sent to the respective input terminals of the 2-to-1 multiplexers 30, 31, and 32 that are selected when the selection control signal A0 is 0. Bits B1, B2 and B3, which are the more significant, four bits B0-B3 of the operand selection input 303 except the least significant bit B0, are sent to the respective input terminals of the 2-to-1 multiplexers 30, 31, and 32 that are selected when the selection control signal A0 is 1.

Therefore, when the operand selection input 302 is even (the least significant bit A0 is 0), the even register number selection circuit 23 selects the more significant, three bits, A1, A2 and A3, of the operand selection input 302 to output bits E1, E2 and E3 representing an even-numbered register to the selection control terminal 311 of the 8-to-1 multiplexer 21. When the operand selection input 302 is odd (the least significant bit A0 is 1), the even register number selection circuit 23 outputs the more significant, three bits, B1, B2 and B3, of the operand selection input 303 to output bits E1, E2 and E3 representing an even-numbered register to the selection control terminal 311 of the 8-to-1 multiplexer 21.

Similarly, the odd register number selection circuit 24 is adapted to select an operand designating an odd-numbered register from the operand selection inputs 302 and 303 sent from the instruction register/decoder 11. Likewise to the even register number selection circuit 23 described above, this circuit 24 outputs three bits, from the second to fourth least significant bits, of the operand selection inputs 302 and 303 whose least significant bit is 1, where the fourth least significant bit is most significant. When both operand selection inputs 302 and 303 indicate an odd-numbered register, the circuit 24 outputs arbitrarily. This circuit 24 may also be adapted to output the entire, four bits indicating the selected register number.

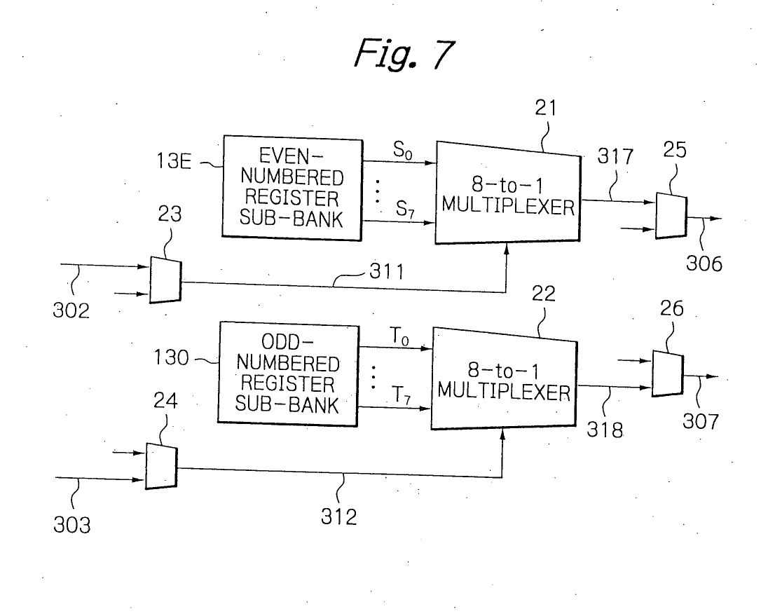

Referring to FIG. 6, the odd register number selection circuit 24 comprises three 2-to-1 multiplexers of 1-bit length 40-42. The least significant bit B0 of four bits B0-B3 of the operand selection input 303 is used as the selection control signal for the 2-to-1 multiplexers 40, 41 and 42. The remaining bits, B1, B2 and B3, are sent to the respective input terminals of the 2-to-1 multiplexers 40, 41, and 42 which are selected in response to the selection control signal B0 being 1. Bits A1, A2 and A3, which are the more significant, four bits A0-A3 of the operand selection input 302 except the least significant bit A0, are sent to the respective input terminals of the 2-to-1 multiplexers 40, 41, and 42 that are selected when the selection control signal B0 is 0.

Therefore, when the operand selection input 303 is odd (the least significant bit B0 is 1), the odd register number selection circuit 24 selects the more significant, three bits, B1, B2 and B3, of the operand selection input 303 to output bits O1, O2 and O3 representing an odd-numbered register to the selection control terminal 312 of the 8-to-1 multiplexer 22. When the operand selection input 303 is even (the least significant bit B0 is 0), the odd register number selection circuit 24 selects the more significant, three bits, A1, A2 and A3, of the operand selection input 302 to output bits O1, O2 and O3 representing an odd-numbered register to the selection control terminal 312 of the 8-to-1 multiplexer 22.

The 2-to-1 multiplexer 25 is adapted to receive the register value 317 output by the 8-to-1 multiplexer 21 on the even-numbered register side and the register value output 318 by the 8-to-1 multiplexer 22 on the odd-numbered register side and selects one of them. In addition, the 2-to-1 multiplexer 25 is adapted to receive the least significant bit of the operand selection input 302 as its selection control input 315.

The 2-to-1 multiplexer 25 selects one of the two register values, that is, the register value from the even-numbered register sub-bank 13E and the register value from the odd-numbered register sub-bank 13O, according to whether the operand selection input 302 is odd or even For example, when the operand selection input 302 is even (the least significant bit 315 is 0), the circuit 25 selects the output 317 of the 8-to-1 multiplexer 21 on the even-numbered register side; when the operand selection input 302 is odd (the least significant bit is 1), the circuit 25 selects the output 318 of the 8-to-1 multiplexer 22 on the odd-numbered register side and outputs it as the operand output 306.

As described above, the 2-to-1 multiplexer (operand 3 output selection circuit) 26 is also adapted to receive the register value 317 output by the 8-to-1 multiplexer 21 on the even-numbered register side and the register value 318 output by the 8-to-1 multiplexer 22 on the odd-numbered register side and selects one of them In addition, the 2-to-1 multiplexer 26 is adapted to receive the least significant bit of the operand selection input 303 as its selection control input 316

The 2-to-1 multiplexer 26 selects one of the two register values, that is, the register value from the even-numbered register sub-bank 13E and the register value from the odd-numbered register bank 130, according to whether the operand selection input 303 is odd or even. For example, when the operand selection input 303 is even (the least significant bit 316 is 0), the circuit 26 selects the output 317 of the 8-to-1 multiplexer 21 on the even-numbered register side; when the operand selection input 303 is odd (the least significant bit is 1), the circuit 26 selects the output 318 of the 8-to-1 multiplexer 22 on the odd-numbered register side and outputs it as the operand output 307.

The operation of the register read circuit 12 in the embodiment will be described below by way of example. First, the operation of the instruction in Example 3 described earlier will be described. The instruction, STORE Rn, [ERm], is to store the contents of register Rn into the memory location whose address has more and less significant positions specified by registers Rm+1 and Rm, respectively. When m is even, m+1 is odd, of course. Therefore, the instruction register/decoder 11 outputs register numbers n, m, and m+1 (each 4 bits) on the operand selection inputs 301, 302 and 303, respectively.

In response to the operand selection input 301, which is now n, given as the selection control input, the 16-to-1 multiplexer 20 selects the register value corresponding to the register number n and outputs the selected register value as the operand output 305.

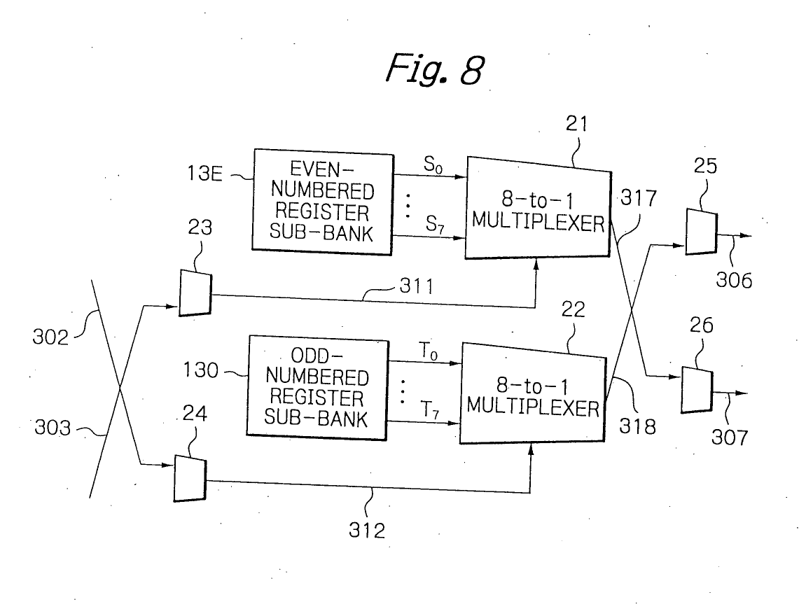

The operand selection input 302, which is now m (even in this example), is sent to the even register number selection circuit 23 and to the odd register number selection circuit 24. Because the number m is even, the even register number selection circuit 23 selects the number m and sends it to the 8-to-1 multiplexer 21 on the even-numbered register side on the selection control input 311, as shown in FIG. 7. More precisely, the more significant, three bits of the operand selection input 302 are sent to the 8-to-1 multiplexer 21 on the selection control input 311.

Then, the 8-to-1 multiplexer 21 selects the register value, corresponding to the register number m, among the register values S0-S7 sent from the even-numbered register sub-bank 13E and sends out the selected register value 317 to the 2-to-1 multiplexers 25 and 26.

Similarly, the operand selection input 303, which is m+1 (odd in this example), is sent to the even and odd register number selection circuits 23 and 24. Since the number m+1 is odd, the odd register number selection circuit 24 selects the number m+1 and sends it to the 8-to-1 multiplexer 22 on the odd-numbered register side on the selection control input 312, as shown in FIG. 7. More precisely, the more significant, three bits of the operand selection input 303 are sent to the 8-to-1 multiplexer 22 on the selection control input 312.

The 8-to-1 multiplexer 22 in turn selects the register value, corresponding to the register number m+1, among the register values T0-T7 sent from the odd-numbered register sub-bank 13O and sends out the selected register value 318 to the 2-to-1 multiplexers 25 and 26.

The least significant bit of the operand selection input 302, which is now m, is sent to the 2-to-1 multiplexer 25 on the selection control input 315. Because this bit 315 is even (0), the 2-to-1 multiplexer 25 selects the register value 317 from the 8-to-1 multiplexer 21 on the even-numbered register side and outputs the selected register value 317 on the operand output 306, as shown in FIG. 7

Likewise, the least significant bit of the operand selection input 303, which is presently m+1, is sent to the 2-to-1 multiplexer 26 on the selection control input 316. Because this bit is odd (1), the 2-to-1 multiplexer 26 selects the register value 318 from the 8-to-1 multiplexer 22 on the odd-numbered register side and outputs the selected register value 318 on the operand output 307, as shown in FIG. 7.

Next, the operation of the instruction in Example 4 described above will be described. The instruction, SRL Rn, Rm, is to shift right data whose more and less significant positions include data stored in the registers Rn+1 and Rn, respectively, by the number of positions specified by the register Rm, and then store the less significant bits of the result into the register Rn. In this example, the number n may be odd or even. In the description below, the number n is assumed to be odd. The instruction register/decoder 11 outputs register numbers m, n, and n+1 (each 4 bits) as the operand selection inputs 301, 302 and 303, respectively.

In response to the operand selection input 301, which is now m, given as the selection control input, the 16-to-1 multiplexer 20 selects the register value corresponding to the register number m and outputs the selected register value on the operand selection input 305.

The operand selection input 302, which is n (odd in this instance), is sent to the even and odd register number selection circuits 23 and 24. Because number n is odd, the odd register number selection circuit 24 selects number n and sends it out to the 8-to-1 multiplexer 22 on the odd-numbered register side on the selection control input 312, as shown in FIG. 8. More precisely, the more significant, three bits are sent.

Then, the 8-to-1 multiplexer 22 selects the register value, corresponding to the register number n, from the register values T0-T7 sent from the odd-numbered register sub-bank 13O and sends out the selected register value 318 to the 2-to-1 multiplexers 25 and 26.

The operand selection input 303, which is n+1 (even in this instance), is sent to the even register number selection circuit 23 and to the odd register number selection circuit 24. Because the number n+1 is even, the even register number selection circuit 23 selects number n+1 and sends it out to the 8-to-1 multiplexer 21 on the even-numbered register side on the selection control input 311, as shown in FIG. 8. More precisely, the more significant, three bits are sent.

Then, the 8-to-1 multiplexer 21 selects the register value, corresponding to the register number n+1, from the register values S0-S7 sent from the even-numbered register sub-bank 13E and sends out the selected register value 317 to the 2-to-1 multiplexers 25 and 26.

The least significant bit of the operand selection input 302, which is n, is sent to the 2-to-1 multiplexer 25 on the selection control input 315. Because this bit is odd (1), the 2-to-1 multiplexer 25 selects the register value 318 from the 8-to-1 multiplexer 22 on the odd-numbered register side and outputs the selected register value 318 on the operand output 306; as shown in FIG. 8.

Further, the least significant bit of the operand selection input 303, which is now n+1, is sent to the 2-to-1 multiplexer 26 on the selection control input 316. Since this bit is even (0), the 2-to-1 multiplexer 26 selects the register value 317 from the 8-to-1 multiplexer 21 on the even-numbered register side and outputs the selected register value 317 on the operand output 307, as shown in FIG. 8.

As described above, in an application with a constraint condition for an implicit operand requiring that one register must be even-numbered and the other register must be odd-numbered, the register read circuit, configured as in the embodiment described above reduces the number of registers whose contents, or register values, are input to the multiplexers, thus reducing the hardware amount of multiplexers and the wiring associated therewith.

The register read circuit 12 in the embodiment described above is based upon the following concept: that the even-numbered operand selection input is sent to the multiplexer dedicated to even-numbered registers, while the odd-numbered operand selection input is sent to the multiplexer dedicated to odd-numbered registers; and that the output of the multiplexer dedicated to even-numbered registers is sent to the operand output requesting an even-numbered register, while the output of the multiplexer dedicated to odd-numbered registers is sent to the operand output requesting an odd-numbered register.

The advantages of the register read circuit 12 in the embodiment will be described by comparing the circuit with that shown in FIGS. 2 and 3. For comparison, assume that the register read circuit shown in FIG. 2 is arranged to the registers having eight bit positions as in this embodiment. Each of the three 16-to-1 multiplexers 2, 3 and 4 of 8-bit length would require fifteen 2-to-1 multiplexers of 8-bit length and each of the 2-to-1 multiplexers of 8-bit length would, in turn, require eight 2-to-1 multiplexers of 1-bit length as shown in FIG. 3. This means that the multiplexers 2, 3 and 4 would require, in its entirety, a total of 360 2-to-1 multiplexers of 1-bit length as given by the expression below,
0.3×15×8=360.

By contrast, the register read circuit 12 in the embodiment requires only 254 2-to-1 multiplexers of one bit position as described below.

The 16-to-1 multiplexer 20 of 8-bit position requires fifteen 2-to-1 multiplexers of 8-bit positions as understood from FIG. 3, and each of the 2-to-1 multiplexers of 8-bit positions is composed of eight 2-to-1 multiplexers. Therefore, the 16-to-1 multiplexer 20 comprises 120 (=15×8) 2-to-1 multiplexers of one bit positions.

Each of the 8-to-1 multiplexers 21 and 22 of 8-bit length, having a three-level tree structure as shown in FIG. 3, requires seven 2-to-1 multiplexers of 8-bit length, and each 2-to-1 multiplexers of 8-bit length is composed of eight 2-to-1 multiplexers of 1-bit length. Therefore, each of the 8-to-1 multiplexer 21 and the 8-to-1 multiplexer 22 comprises 56 7×8) 2-to-1 multiplexers of 1-bit length.

The even and odd register number selection circuits 23 and 24 each comprise three 2-to-1 multiplexers of 1-bit position as shown in FIGS. 5 and 6. The 2-to-1 multiplexers 25 and 26 of 8-bit length each comprise eight 2-to-1 multiplexers of 1-bit length. Therefore, each comprises eight (=1×8) 2-to-1 multiplexers of 1-bit length. Thus, the total number of 2-to-1 multiplexers of 1-bit length used in the components 20, . . . , 26 is 254 (=120+56+56+3+3+8+8).

It is expected from the above description that the size of the register read circuit 12 in the illustrative embodiment is 70% (=(254/360)×100) of that of the circuit shown in FIGS. 2 and 3.

In addition, in the register read circuit in FIGS. 2 and 3, because the 8-bit wiring is required between each of 16 registers and each of three 16-to-1 multiplexers of 8-bit length 2-4, the wiring between the register (bank) and the register read circuit requires a total of 384 (=16×3×8) connections.

By contrast, the register read circuit 12 in the embodiment uses the 8-bit wiring between each of the 16 registers and the one 16-to-1 multiplexer 20 of 8-bit length, and the two pairs of 8-bit connections between each of the eight registers and the one 8-to-1 multiplexer of 8-bit length. A total of 256 (=16×1×8+8×1×8×2) connections are therefore required.

As described above, the register read circuit 12 in the embodiment significantly reduces the number of wires as compared with that used in the circuit in FIGS. 2 and 3.

The microprocessor 10 including the register read circuit 12 in the embodiment is compact and simple because the register read circuit 12 is smaller in components amount of wiring.

An alternative embodiment of a register read circuit and a microprocessor according to the present invention will be described. The embodiment described above is adapted to operate two operands corresponding to consecutive register numbers. In the alternative embodiment, four operands corresponding to consecutive register numbers are processed.

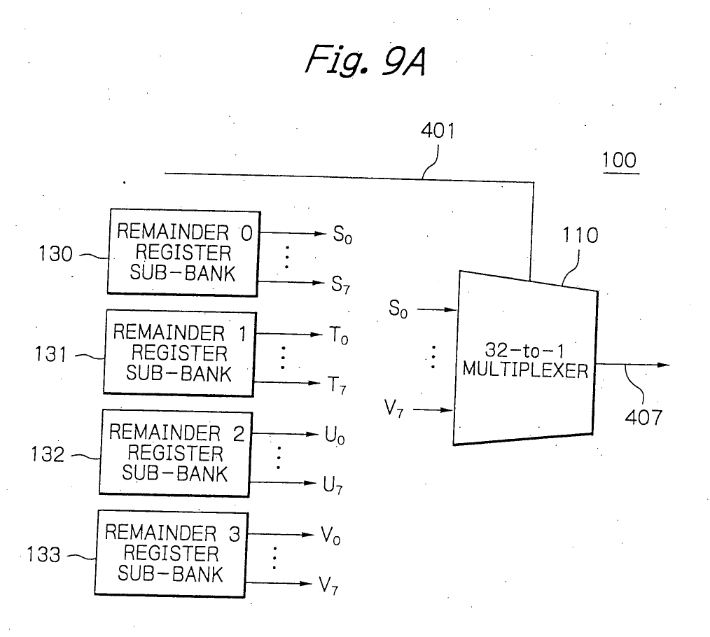

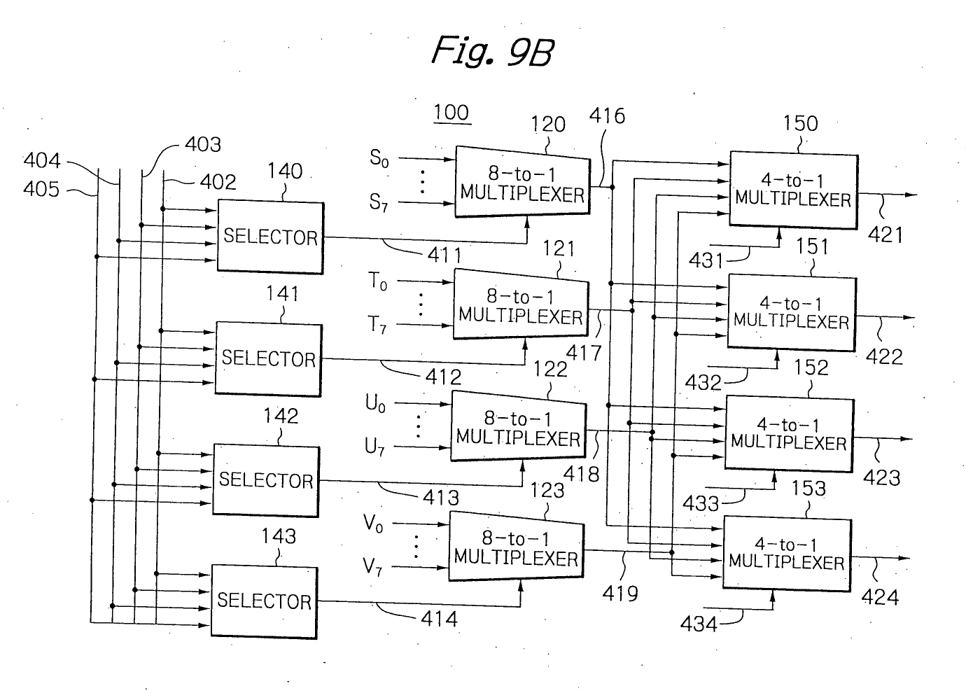

The alternative embodiment includes an instruction register/decoder, not shown, which is adapted to retain and decode a received instruction, and send information on the decoded instruction to an arithmetic and logical unit (ALU) not shown, and data on up to five operands (register numbers) to a register read circuit 100, FIGS. 9A and 9B, on its operand selection inputs 401. In the instant embodiment, some instructions decoded by the instruction register/decoder have an implicit operand. When decoding such an instruction, the instruction register/decoder outputs consecutive register numbers on its operand selection inputs 402-405. The instruction register/decoder may be adapted to decode an instruction for which up to five explicit operands are specified.

With reference to FIGS. 9A and 9B, the embodiment is adapted to the configuration in which the number of registers (N) is 32. Also, only for simplicity for describing the embodiment, the number of bits (n) for representing a register number is five (2⁵=32). That is, a register number ranges from 0 to 31 in decimal notation. When the register number reaches the maximum (N−1=31; odd number), the next consecutive number will be 0 (even number) that is considered larger than the maximum by 1. In addition, the number of bits of a register is 8.

Referring to FIGS. 9A and 9B, the register read circuit 100 comprises a 32-to-1 multiplexer 110 of 8-bit length, four 8-to-1 multiplexers 120-123 of 8-bit length, a remainder 0-3 register number selectors 140-143, respectively, and four 4-to-1 multiplexers 150-153 of 8-bit length. In addition, the register bank from which the register read circuit 100 in the embodiment reads out a register value comprises remainder 0-3 register sub-banks 130-133, respectively.

The remainder 0 register sub-bank 130 comprises registers whose register number of modulo 4 (number of banks) is 0, the least significant, two bits being 00. The contents or the register value (8 bits) of a remainder 0 register, S0, . . . , S7, is connected to be sent to the 32-to-1 multiplexer 110 and to the 8-to-1 multiplexer 120. The register numbers corresponding to register values S0, . . . , S7 are 0, 4, . . . , 28 in the decimal notation.

Similarly, the remainder 1 register sub-bank 131 to remainder 3 register sub-bank 133 each comprise registers whose register number of modulo 4 is 1, 2 or 3, respectively, the least significant, two bits being 01, 10, and 11 respectively.

The remainder 1 register sub-bank 131 has its output of a remainder 1 register number, T0, . . . , T7, interconnected to the 32-to-1 multiplexer 110 and to the 8-to-1 multiplexer 121. Similarly, the register numbers corresponding to register values T0, . . . , T7 are 1, 5, . . . , 29. Also, the value of a remainder 2 register, U0, . . . , U7, from the remainder 2 register bank 132 is sent to the 32-to-1 multiplexer 110 and to the 8-to-1 multiplexer 122. The register numbers corresponding to register values U0, . . . , U7 are 2, 6, . . . , 30. In addition, the value of a remainder 3 register, V0, . . . , V7, from the remainder 3 register bank 133 is sent to the 32-to-1 multiplexer 110 and to the 8-to-1 multiplexer 123. The register numbers corresponding to register values V0, . . . , V7 are 3, 7, . . . 31.

The even numbers in the embodiment described with reference to FIG. 1 correspond to the remainder 0 resultant from a register number of modulo 2, where the number of banks is 2, and the odd numbers in the embodiment correspond to the remainder 1 from a register number of modulo 2. Thus, both embodiments are based on the same technological concept.

The 32-to-1 multiplexer 110 is adapted to select one of all register values S0-S7, T0-T7, U0-U7, and V0-V7 which corresponds to the register number specified by the operand selection input 401 from the instruction register/decoder, and output the selected register value on its operand selection output 407.

The 8-to-1 multiplexer 120 is adapted to select, among the register values S0-S7 associated with the remainder 0 register number, a register value corresponding to the register number 411 sent from the remainder 0 register number selector 140. The register number may include only the more significant, three bits than the two bits which are always 00. The multiplexer 120 outputs the selected register value 416 to all 4-to-1 multiplexers 150-153.

Similarly, the 8-to-1 multiplexers 121-123 are each adapted to select, among the register values T0-T7, U0-U7, or V0-V7, a register value corresponding to the register number 412, 413 or 414 sent from the remainder 1, 2 or 3 register number selector 141, 142 or 143, respectively, and output the selected register value 417, 418 or 419, respectively, to all 4-to-1 multiplexers 150-153.

The remainder 0 register number selector 140 is adapted to receive the operand selection inputs (register numbers) 402-405 sent from the instruction register/decoder, not shown, and select one of the operand selection inputs 402-405, which corresponds to a modulo 4 remainder 0 of a register number, the least significant, two bits being 00.

The remainder 0 register number selector 140 may comprise, for example, a comparator, not shown, which is adapted to compare the least significant, two bits of each of the operand selection input 402-405 with 00 and a gate circuit, not shown, that allows one of the operand selection inputs 402-405 to be passed in response to the comparison result.

Similarly, the remainder 1, 2 and 3 register number selectors 141, 142 and 143 are each adapted to receive the operand selection inputs (register numbers) 402-405 and select one of the operand selection inputs, which corresponds to a modulo-4 remainder 1, 2 or 3, respectively, of a register number, the least significant two bits being 01, 10, 11, respectively.

As described above, four register values 416-419 from the four 8-to-1 multiplexers 120-123, respectively, are sent to the 4-to-1 multiplexer (operand 2 output selection circuit) 150 on its selection inputs. In addition, the least significant, two bits of the operand selection input 402 are sent to the 4-to-1 multiplexer 150 on its selection control input 431.

The 4-to-1 multiplexer 150 selects the output of the 8-to-1 multiplexer 120 when the remainder resultant from dividing the operand selection input 402 by 4 is 0. Likewise, the 4-to-1 multiplexer 150 selects the output of the 8-to-1 multiplexer 121, 122 or 123 when the remainder is 1, 2 or 3, respectively. Then, the 4-to-1 multiplexer 150 outputs the selected output on its operand output 421.

Similarly, the 4-to-1 multiplexers 151, 152 and 153 each select one of four 8-to-1 multiplexers 120-123 in response to the least significant, two bits 432, 433 or 434 of the operand selection input 403, 404 or 405, respectively, and outputs the selected output on the operand output 422, 423 or 424 thereof.

From the above description on the configuration of the register read circuit 100 in the alternative embodiment, and the operation of the embodiment shown in FIG. 1, the operation of the register read circuit 100 in the alternative embodiment may be self-explanatory so that the description of the operation of the register read circuit 100 is omitted.

It is understood that an extension of the circuitry described with reference to FIGS. 2 and 3 would need five 32-to-1 multiplexers, not shown, which are like the multiplexer 110, FIG. 9A, for four operands corresponding to consecutive registers. By contrast to this circuit, the register read circuit 100 in the alternative embodiment makes the circuit smaller and reduces the amount of wiring. The microprocessor including the register read circuit 100 in the alternative embodiment is compact and simple.

The number of registers to be read by the register read circuit, the number of bits of each register, and the number of consecutive registers to be read need not be those involved in the above-described embodiments, but may be any number. Nor need the number of registers be a power of 2.

In addition, the number of operands (the first operand in the embodiments), designating a register number independently of register numbers defined in other operands, need not be 1, but may be 0 or 2 or more.

Although the register read circuit according to the present invention is designed for application in a microprocessor, the register read circuit may be applicable, and gives the same effect, to a unit other than a microprocessor, as long as a plurality of values must be read out from a register bank and the registers that are read are related with each other as established in the above-described embodiments.

As described above, the present invention provides a register read circuit and a microprocessor that make the circuit size and the wiring amount smaller than those of the circuit shown in FIGS. 2 and 3.

The entire disclosure of Japanese patent application No. 2001-286102 filed on Sep. 20, 2001, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

1-11. (canceled)

12. A register read circuit that reads register values from a plurality of registers grouped into n register sub-banks, comprising:
a first multiplexer, coupled to each of the register sub-banks, that selectively outputs one of the register values from the plurality of registers as a first operand output, responsive to a first operand selection input;
n second multiplexers coupled to respective ones of the register sub-banks, each of the second multiplexers selectively outputs a register value from the register sub-bank coupled thereto as a selected register value responsive to a respective register selection number;
n register selection circuits, each of the register selection circuits coupled to receive n second operand selection inputs and to selectively output most significant bits of one of the second operand selection inputs as a respective register selection number responsive to least significant bits of a corresponding predetermined one of the second operand selection inputs; and
n output selection circuits, each of the output selection circuits coupled to receive the selected register values output from each of the second multiplexers and to respectively output one of the selected register values as a second operand output responsive to the least significant bits of the second operand selection inputs,
wherein the plurality of registers include N registers which are grouped so that the register sub-banks each include p registers, the first multiplexer is an N to 1 multiplexer, the second multiplexers are p to 1 multiplexers, and p, n and N are non-zero integers and p<N.

13. The register read circuit of claim 12, wherein n=2, p=8, and N=16.

14. The register read circuit of claim 12, wherein n=4, p=8, and N=32.

15. A microprocessor comprising:
a plurality of registers grouped into n register sub-banks;
an instruction decode circuit that decodes an instruction and provides a first operand selection value and n second operand selection values responsive to the decoded instruction; and
a register read circuit that reads register values from the plurality of registers to provide operand outputs, the register read circuit including
a first multiplexer, coupled to each of the register sub-banks, that selectively outputs one of the register values from the plurality of registers as a first operand output, responsive to the first operand selection value,
n second multiplexers coupled to respective ones of the register sub-banks, each of the second multiplexers selectively outputs a register value from the register sub-bank coupled thereto as a selected register value responsive to a respective register selection number,
n register selection circuits, each of the register selection circuits coupled to receive the n second operand selection values and to selectively output most significant bits of one of the second operand selection values as a respective register selection number responsive to least significant bits of a corresponding predetermined one of the second operand selection values, and
n output selection circuits, each of the output selection circuits coupled to receive the selected register values output from each of the second multiplexers and to respectively output one of the selected register values as a second operand output responsive to the least significant bits of the second operand selection values,
wherein the plurality of registers include N registers which are grouped so that the register sub-banks each include p registers, the first multiplexer is an N to 1 multiplexer, the second multiplexers are p to 1 multiplexers, and p, n and N are non-zero integers and p<N.

16. The microprocessor of claim 15, wherein n=2, p=8, and N=16.

17. The microprocessor of claim 15, wherein n=4, p=8, and N=32.
